(19) United States
(12) Patent Application Publication
(10) Pub. No.: US 2009/0146771 A1
(43) Pub. Date: Jun. 11, 2009

(54) Apparatus for Generating Secondary Electricity from an Electromagnetic Field Around a Wire

(75) Inventors: Min-Yueh Chiang, Sanchong City (TW); Pi-Pai Chang, Taitung City (TW)

Correspondence Address: TROXELL LAW OFFICE PLLC, 5205 LEESBURG PIKE, SUITE 1404, FALLS CHURCH, VA, 22041, US

(73) Assignees: MIN-YUEH CHIANG, Taipei County (TW); PI-PAI CHANG, Taitung County (TW)

(21) Appl. No.: 12/329,568

(22) Filed: Dec. 6, 2008

(30) Foreign Application Priority Data
Dec. 6, 2007 (TW) 096146545

(51) Int. Cl. H01F 27/28

(52) U.S. Cl. 336/220

(57) ABSTRACT

Disclosed is an apparatus for generating secondary electricity from an electromagnetic field around a wire. The apparatus includes a coil unit, a wire and a rectifier. The coil unit comprising a highly magnetically conductive ring and a coil provided wound around the highly magnetically conductive ring. The wire is wound around the highly magnetically conductive ring. The rectifier is connected to the coil.

### BACKGROUND OF INVENTION

1. Field of Invention

The present invention relates to an apparatus for generating secondary electricity from an electromagnetic field around a wire.

2. Related Prior Art

Energy is the basis for the development and use of resources on the earth. The development of the technology and delicate ways of living are results of effective use of the resources. Electricity is the most convenient energy source. For centuries, scientists and engineers are working on various techniques for generating electricity to spur the development of the economy and the advance of the society.

Wind power, hydraulic power, thermal power, nuclear power, solar energy have been used to generate electricity. The equipment for generating electricity is bulky, complicated and cannot easily be built. The maintenance of the equipment is troublesome. Wind power, hydraulic power and solar energy for economic use are not everywhere, and the provision of electricity from wind power, hydraulic power and solar energy is not reliable. Thermal power and nuclear power however produce toxic waste that is potentially dangerous to the environment. People are working hard to exploit reliable, sustainable and clean energy.

On the other hand, people are been reminded of saving energy and using energy carefully. An approach is to exploit secondary energy, i.e., reusing energy that would otherwise be wasted.

The present invention is therefore intended to obviate or at least alleviate the problems encountered in prior art.

### SUMMARY OF INVENTION

The primary objective of the present invention is to increase an apparatus for generating secondary electricity from an electromagnetic field around a wire.

According to the present invention, the apparatus includes a coil unit, a wire and a rectifier. The coil unit comprising a highly magnetically conductive ring and a coil provided wound around the highly magnetically conductive ring. The wire is wound around the highly magnetically conductive ring. The rectifier is connected to the coil.

Other objectives, advantages and features of the present invention will become apparent from the following description referring to the attached drawings.

### BRIEF DESCRIPTION OF DRAWINGS

The present invention will be described via the detailed illustration of three embodiments referring to the drawings.

FIG. 1 is a block diagram of an apparatus for generating secondary electricity from an electromagnetic field around a wire according to the first embodiment of the present invention.

FIG. 2 is a block diagram of an apparatus for generating secondary electricity from an electromagnetic field around a wire according to the second embodiment of the present invention.

FIG. 3 is a block diagram of an apparatus for generating secondary electricity from an electromagnetic field around a wire according to the third embodiment of the present invention.

FIG. 4 is a block diagram of the apparatus shown in FIG. 1 working in a first mode.

FIG. 5 is a block diagram of the apparatus shown in FIG. 1 working in a second mode.

### DETAILED DESCRIPTION OF EMBODIMENTS

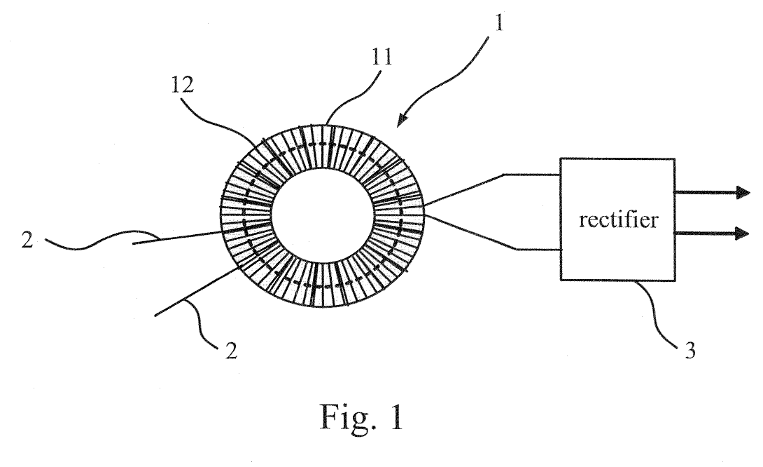

Referring to FIG. 1, there is shown an apparatus for generating secondary electricity from an electromagnetic field around a wire according to a first embodiment of the present invention. The apparatus includes at least one coil unit 1, a wire 2 and a rectifier 3.

The coil unit 1 includes a highly magnetically conductive ring 11 and a coil 12 wound around the highly magnetically conductive ring 11.

The wire 2 may transmit an alternative current. The wire 2 is provided around the highly magnetically conductive ring 11. The wire 2 may be a power wire of an electric appliance or a power wire of the mains.

The rectifier 3 is connected to the coil 12. Thus, the apparatus can generate secondary electricity from an electromagnetic field around the wire 2.

When a current travels in the wire 2, an electromagnetic field occurs around the wire 2. The wire 2 is regularly wound around the highly magnetically conductive ring 11 so that the electromagnetic field is intensive and even. The coil 12 generates electricity from the electromagnetic field according to the Farad's rule. The size and material of the highly magnetically conductive ring 11 and the number of the rounds of the coil 12 can be changed in relation to each other, based on the current traveling in the wire 2.

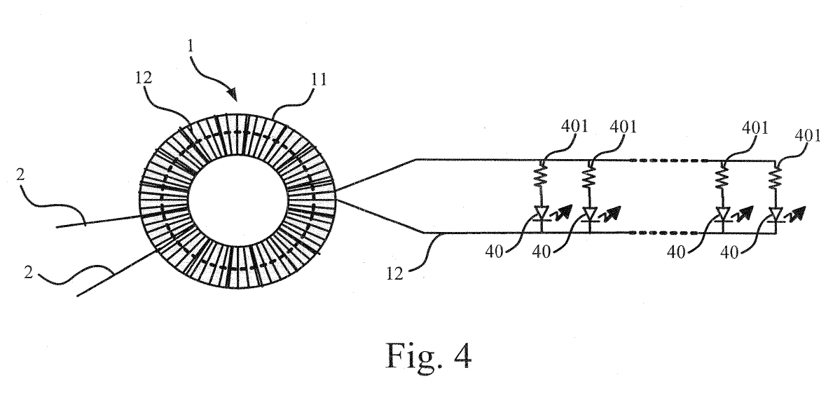

Referring to FIG. 4, there is shown an example of using the apparatus shown in FIG. 1. Lights 40 are connected, in parallel, to light the coil 12. The lights 40 may be light-emitting diodes for example. A regulator 401 is connected to each of the lights 40. Thus, as the current travels in the wire 2, the secondary electricity travels in the lights 40 and regulators 401. This system is used for illumination.

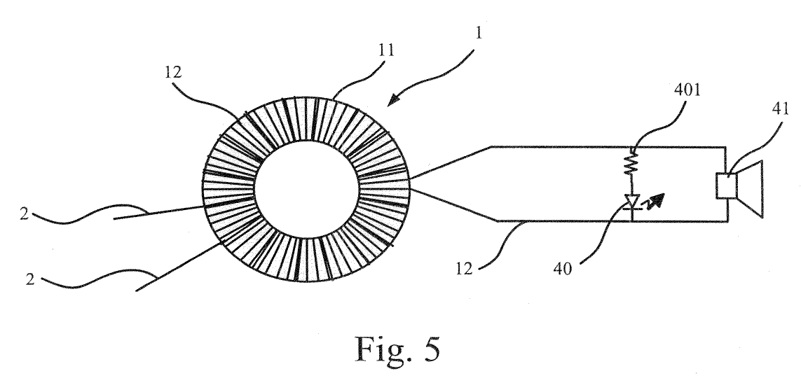

Referring to FIG. 5, there is shown another example in using the apparatus shown in FIG. 1. A light 40 and a buzzer 41 are connected, in parallel, to the coil 12. A regulator 401 is connected to the light 40. This system is used for warning of overloads on the wire 2.

Although not shown, a battery could be connected to the coil 12. Thus, the secondary electricity can be stored in such a battery.

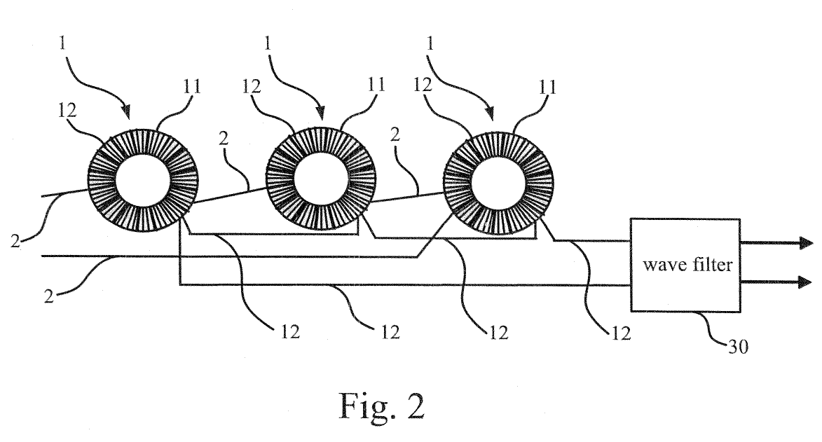

Referring to FIG. 2, there is shown an apparatus for generating secondary electricity from an electromagnetic field around a wire according to a second embodiment of the present invention. The second embodiment is identical to the first embodiment except for two things. Firstly, a rectifier-filter 30 is used instead of the rectifier 3. Secondly, there are three coil units 1 instead of the single coil unit 1. The wire 2 is wound around the highly magnetically conductive rings 11. The coils 12 are connected, in series, to the rectifier-filter 30.

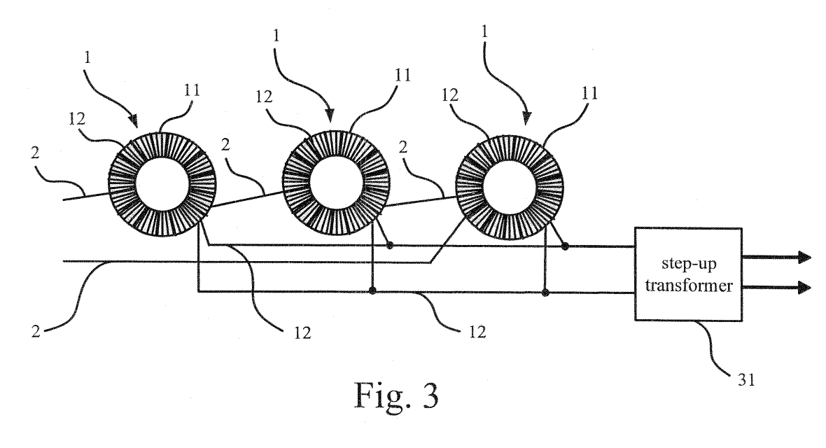

Referring to FIG. 3, there is shown an apparatus for generating secondary electricity from an electromagnetic field around a wire according to a third embodiment of the present invention. The third embodiment is identical to the second embodiment except for two things. Firstly, a step-up transformer 31 is used instead of the rectifier-filter 30. Secondly, the coils 12 are connected, in parallel, to the step-up transformer 31.

The present invention has been described via the detailed illustration of the embodiments. Those skilled in the art can derive variations from the embodiments without departing from the scope of the present invention. Therefore, the embodiments shall not limit the scope of the present invention defined in the claims.

1. An apparatus for generating secondary electricity from an electromagnetic field around a wire comprising:
at least one coil unit comprising a highly magnetically conductive ring and a coil provided wound around the highly magnetically conductive ring;
a wire wound around the highly magnetically conductive ring; and
a rectifier connected to the coil.

2. The apparatus according to claim 1, wherein the wire is a power wire of an electric appliance.

3. The apparatus according to claim 1, wherein the wire is a power wire of the mains.

4. The apparatus according to claim 1 comprising a plurality of coil units connected to the rectifier.

5. The apparatus according to claim 4, wherein the coil units are connected to the rectifier in series.

6. The apparatus according to claim 4 wherein the coil units are connected to the rectifier in parallel.

7. The apparatus according to claim 1, wherein the rectifier is a rectifier-filter.

8. The apparatus according to claim 1, wherein the rectifier is a step-up transformer.
